(19) United States
(12) Patent Application Publication
(10) Pub. No.: US 2024/0303523 A1
(43) Pub. Date: Sep. 12, 2024

(54) APPARATUS AND METHOD FOR PERFORMING FAULT-TOLERANT LOGICAL HADAMARD GATE OPERATION

(71) Applicant: Electronics and Telecommunications Research Institute, Daejeon (KR)

(72) Inventors: Sang-Min LEE, Daejeon (KR); Young-Chul KIM, Daejeon (KR); Soo-Cheol OH, Daejeon (KR); Jin-Ho ON, Daejeon (KR); Ki-Sung JIN, Daejeon (KR); Gyu-Il CHA, Daejeon (KR)

(73) Assignee: Electronics and Telecommunications Research Institute, Daejeon (KR)

(21) Appl. No.: 18/515,564

(22) Filed: Nov. 21, 2023

(30) Foreign Application Priority Data
Nov. 25, 2022 (KR) 10-2022-0160158
Oct. 10, 2023 (KR) 10-2023-0134271

(51) Int. Cl. G06N 10/40

(52) U.S. Cl. CPC G06N 10/40

(57) ABSTRACT

Disclosed herein are an apparatus and method for performing a fault-tolerant logical Hadamard gate operation. The apparatus is configured to perform a transversal logical Hadamard (H) operation of defining a logical quantum state and logical operators of a Hadamard-transformed logical qubit on a logical qubit of a prepared encoding flavor having an arbitrary quantum state, deform a boundary of the logical qubit while maintaining the logical quantum state using a boundary deformation technology, and perform an automatic flip of transforming a flavor of the logical qubit by flipping a rotated surface code while maintaining the logical quantum state and the definition of logical operators.

### CROSS REFERENCE TO RELATED APPLICATIONS

This application claims the benefit of Korean Patent Application No. 10-2022-0160158, filed Nov. 25, 2022 and 10-2023-0134271, filed Oct. 10, 2023, which are hereby incorporated by reference in their entireties into this application.

### BACKGROUND OF THE INVENTION

### 1. Technical Field

The present disclosure relates generally to quantum computing technology, and more particularly to quantum error correction technology and fault-tolerant logical Hadamard gate operation technology.

### 2. Description of the Related Art

Quantum computing provides significantly higher performance compared to classical computers, but it is difficult to perform large-scale operations (computations) due to high error rate and low stability problems. Quantum error correction code is technology for supporting fault-tolerant quantum computations through periodic error detection and correction by encoding many physical qubits into a logical qubit (hereinafter referred to as “LQ”). Among current various technologies, technology for supporting a high error threshold with a smallest number of physical qubits is rotated surface code.

In the rotated surface code logical qubits, a quantum gate processes qubit operations in a transversal manner in which the corresponding quantum gate is directly applied to physical qubits or in a lattice surgery (hereinafter referred to as “LS”) manner which utilizes logical operator measurement technology. Generally, a logical Hadamard gate processes qubit operations in the transversal manner in which a physical Hadamard gate is applied to all data qubits forming the logical qubit. Although this is an easy intuitive scheme and is capable of processing qubit operations in a fault-tolerant manner without propagating errors to other qubits, a problem arises in that a logical X operator and a logical Z operator of a logical qubit are mutually exchanged due to the application of a logical Hadamard gate.

The problem related to the exchange of logical operators causes difficulty in processing a logical qubit operation in which multiple logical qubits participate in an LS manner. In the LS manner, an operation on two logical qubits may be processed through the measurement of two logical Z operators based on two different X boundaries (i.e., logical ZZ measurement) or the one of two logical X operators (i.e., logical XX measurement) based on two different Z boundaries. Here, the logical operator measurement denotes computation technology for merging two logical qubits into a single logical qubit and then splitting the merged logical qubit. Because the logical operator measurement can be performed in an optimal space only when the boundaries of two logical qubits for performing the logical operator measurement are identical to each other, there is required a logical Hadamard (hereinafter referred to as ‘H’) gate operation method in which the definitions of logical X and Z operators are maintained without being exchanged.

Meanwhile, U.S. Patent Application Publication No. US2021/0374588 entitled “Low overhead quantum computation using lattice surgery” discloses a method for restoring logical qubits in which a logical X operator and a logical Z operator are mutually exchanged to the state before the exchange by utilizing a number of physical qubits that are three or more times the number of logical qubits.

### SUMMARY OF THE INVENTION

Accordingly, the present disclosure has been made keeping in mind the above problems occurring in the prior art, and an object of the present disclosure is to solve the problem in which logical X and Z operators (hereinafter referred to as “logical Pauli operators”) are mutually exchanged with each other as a quantum state is Hadamard-transformed when a transversal logical H gate is applied to quantum error correction code.

Another object of the present disclosure is to provide a method for preventing from influencing a logical quantum state in a rotated logical qubit, minimizing an influence on the quantum state and operation of adjacent other logical qubits, and decreasing the number of necessary physical qubits and a physical qubit computational load.

A further object of the present disclosure is to reduce the number of processing depths of a quantum circuit by performing logical H gate operations in parallel on multiple rotated logical qubits.

In accordance with an aspect of the present disclosure to accomplish the above objects, there is provided an apparatus for performing a fault-tolerant logical Hadamard gate operation, including one or more processors, and a memory configured to store at least one program that is executed by the one or more processors, wherein the at least one program is configured to perform a transversal logical Hadamard (H) operation of defining a logical quantum state and logical Pauli operators of a Hadamard-transformed logical qubit on a logical qubit of a prepared encoding flavor having an arbitrary quantum state, deform a boundary of the logical qubit while preserving the logical quantum state using a boundary deformation technology, and perform an automatic flip of transforming a flavor of the logical qubit by flipping a rotated surface code while maintaining the logical quantum state and the definition of the logical Pauli operators.

The at least one program may be configured to define a logical H operation execution circuit based on the definition of the logical operators including deform and automatic flip.

The at least one program may be configured to define a deform operator corresponding to a single logical qubit operation and correct the logical quantum state by applying the logical Pauli operators to the boundary-deformed logical qubit depending on two calculated values.

The at least one program may be configured to deform the boundary by controlling activation of boundary stabilizers in a rotated logical qubit, and to change the definition of the logical Pauli operators while preserving the logical quantum state through post-correction.

The at least one program may be configured to define an expand operator and a shift operator and to flip the flavor of the logical qubit by selectively performing either a vertical flip or a horizontal flip depending on the logical qubit layout configuration.

The at least one program may be configured to construct an expanded logical qubit by adding the preset size of physical qubits to the logical qubit, and thereafter extract a flipped logical qubit by measuring the preset size of physical qubits.

In accordance with another aspect of the present disclosure to accomplish the above objects, there is provided a method for performing a fault-tolerant logical Hadamard gate operation, the method being performed by an apparatus for performing a fault-tolerant logical Hadamard gate operation, the method including performing a transversal logical Hadamard (H) operation of defining a logical quantum state and logical Pauli operators of a Hadamard-transformed logical qubit on a logical qubit of a prepared encoding flavor having an arbitrary quantum state, deforming the boundary of the logical qubit while preserving the logical quantum state using a boundary deformation technology, and performing an automatic flip (hereinafter referred to as “auto-flip”) of transforming the flavor of the logical qubit by flipping a rotated surface code while maintaining the logical quantum state and the definition of the logical Pauli operators.

Performing the transversal logical H operation may include defining a logical H operation execution circuit based on the definition of the logical operators including deform and auto-flip.

Deforming the boundary may include defining a deform operator corresponding to a single logical qubit operation, and correcting the logical quantum state by applying the logical Pauli operators to the boundary-deformed logical qubit depending on two calculated values.

Deforming the boundary may further include deforming the boundary by controlling activation of boundary stabilizers in a rotated logical qubit, and changing the definition of the logical Pauli operators while preserving the logical quantum state through post-correction.

Performing the automatic flip may include defining an expand operator and a shift operator, and flipping the flavor of the logical qubit by selectively performing either a vertical flip or a horizontal flip depending on the logical qubit layout configuration.

Performing the automatic flip may further include constructing an expanded logical qubit by adding the preset size of physical qubits to the logical qubit, and thereafter extracting a flipped logical qubit by measuring the preset size of physical qubits.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are diagrams illustrating a rotated surface code logical qubit in a 2D physical qubit array according to an embodiment of the present disclosure;

FIG. 3 is a diagram illustrating a rotated logical qubit to which a transversal logical H gate is applied according to an embodiment of the present disclosure;

FIGS. 4 and 5 are diagrams illustrating a logical H gate operation process of a rotated surface code according to an embodiment of the present disclosure;

FIGS. 6A and 6B and FIGS. 7A and 7B are diagrams illustrating boundary deformation technology for a rotated logical qubit according to an embodiment of the present disclosure;

FIGS. 8A and 8B and FIGS. 9A and 9B are diagrams illustrating a process of preserving a logical quantum state in boundary deformation technology according to an embodiment of the present disclosure;

FIG. 10 is a diagram illustrating location-based auto-flip technology for a rotated logical qubit according to an embodiment of the present disclosure;

FIG. 11 is a diagram illustrating an example of parallel processing of multiple logical H gate operations in logical qubit layouts according to an embodiment of the present disclosure;

FIG. 12 is an operation flowchart illustrating a method for performing a fault-tolerant Hadamard operation according to an embodiment of the present disclosure; and

FIG. 13 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, embodiments of the present disclosure will be described in detail with reference to the attached drawings.

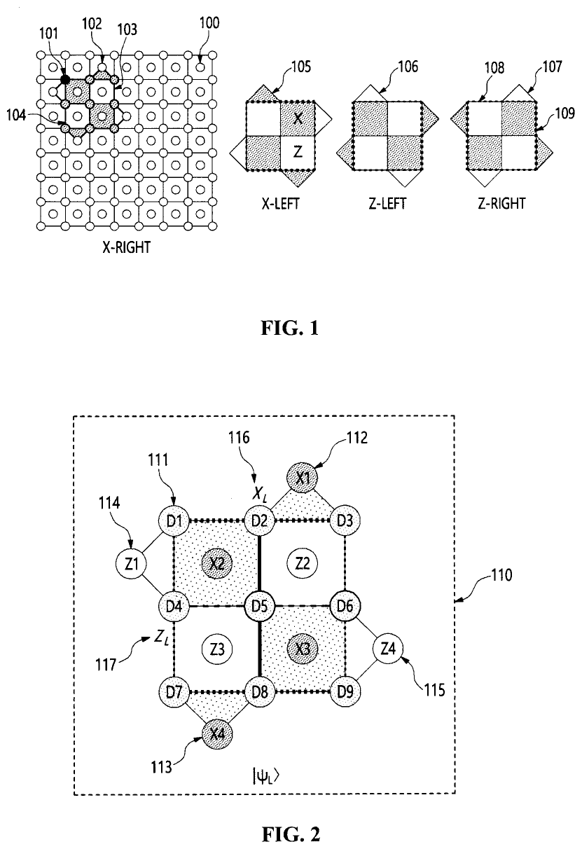

FIGS. 1 and 2 are diagrams illustrating a rotated surface code logical qubit in a 2D physical qubit array according to an embodiment of the present disclosure.

Referring to FIG. 1, it can be seen that a method for performing a fault-tolerant logical Hadamard (H) gate operation while maintaining a logical X operator and a logical Z operator in the rotated surface code logical qubit corresponding to quantum error correction technology is illustrated.

The rotated surface code is configured such that, in a 2D physical qubit array 100, a logical qubit is defined by encoding respective qubits into data qubits 101 in which quantum information is stored and syndrome qubits 102 which detect an error occurring in the data qubits. The size of the logical qubit is determined by distance d defined as the minimum number of physical qubit operations that can be performed without causing errors, and is composed of d² data qubits and d²−1 syndrome qubits.

Referring to FIG. 2, a distance d=3 rotated logical qubit is depicted. It can be seen that a logical qubit 110 may be defined by a total of 17 physical qubits including 9 (=3²) data qubits D1 to D9 and 8 (=3²−1) syndrome qubits. The origin 101 of the logical qubit may indicate the location of a first data qubit in the logical qubit. After respective data qubits are initialized depending on the logical quantum state desired to be defined, measurement circuits may be simultaneously executed in four X syndrome qubits X1 112 to X4 113 and four Z syndrome qubits Z1 114 to Z4 115. This scheme is generally referred to as an error syndrome measurement, and measurement circuits in the X and Z syndrome qubits are referred to as X and Z stabilizers. A triangular shape composed of two data qubits and one syndrome qubit in the logical qubit is called a weight-2 stabilizer 102, and is referred to as a boundary stabilizer in the present disclosure. Further, a rectangular shape composed of four data qubits and one syndrome qubit is called a weight-4 stabilizer 103.

In each Error Syndrome Measurement (ESM) circuit, when neighboring data qubits interacting with each other are in the |0> or |1> state, a Z-basis, the outcome of measurement by the Z stabilizer may always be +1, and the outcome of measurement by the X stabilizer may randomly be ±1. Further, when neighboring data qubits are in the |+> or |−> state, a X-basis, the outcome of measurement by the X stabilizer may always be +1, and the outcome of measurement by the Z stabilizer may randomly be ±1. Therefore, the X stabilizer detects a phase-flip error occurring in the data qubits, and the Z stabilizer detects a bit-flip error. Error correction refers to a process of inferring an error in neighboring data qubits with respect to stabilizers having a measurement outcome of −1 and decoding the measurement outcomes by applying a Pauli-Z or Pauli-X gate thereto so that the measurement outcome becomes +1. When the outcomes of measurement of all syndrome qubits indicate an eigenvalue of +1, the quantum state of the logical qubit indicates that the X and Z stabilizers are stabilized to simultaneous +1 eigenstates, and a logical X operator X_{L} and a logical Z operator Z_{L} are also defined.

In order to describe a change in a logical qubit flavor depending on the application of the logical qubit operation proposed in the present disclosure, an initial logical qubit type (i.e., a prepared LQ flavor) is defined. Here, the flavor is the form of rotated surface code defined by the type and location of a boundary stabilizer in the rotated surface code and is very important in performing a logical qubit operation. The prepared logical qubit flavor according to an embodiment of the present disclosure may denote a logical qubit immediately before a Hadamard transformation is performed, and may define the same logical quantum state |ψ_{L} [symbol] by various flavors 104 to 107 depending on the encoding [symbol] scheme. A boundary may be determined depending on which types of stabilizers are to be used to encode the upper/lower-left/right boundaries 108 and 109 of logical qubits, and the boundary may be used to determine logical qubit flavors. In each logical qubit of FIG. 1, a thin dotted line 108 on which a Z-boundary stabilizer is located denotes a Z boundary, and a thick dotted line 109 on which an X-boundary stabilizer is located denotes an X-boundary. Depending on the location of the boundary stabilizer, the flavor of the logical qubit may be defined as X-Right 104, X-Left 105, Z-Left 106, or Z-Right 107.

In the present disclosure, the prepared logical qubit 110 among various flavors is defined as the X-Right flavor. This flavor defines a logical X operator X_{L}, 116 as a minimum data qubit chain to which the Pauli-X operator can be successively applied between opposite X boundaries without causing errors, and defines a logical Z operator Z_{L} 117 between Z boundaries. This is intended to describe the proposed technology and is technology that can also be applied to various flavors of logical qubits without a limitation in flavors.

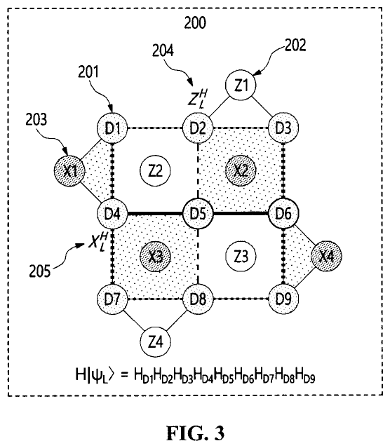

FIG. 3 is a diagram illustrating a rotated logical qubit to which a transversal logical H gate is applied according to an embodiment of the present disclosure.

Referring to FIG. 3, a logical H gate in surface code may be implemented by applying a physical H gate to all data qubits, and thus the quantum state of the logical qubit may be Hadamard-transformed. This shows that the basis state of each data qubit is exchanged between states in the X-basis and the Z-basis, whereby an X stabilizer and a Z stabilizer may also be exchanged with each other.

It can be seen in FIG. 3 that, when the transversal logical H gate is applied to the d-3 rotated logical qubit 110, defined in FIGS. 1 and 2, the change in the flavor of the logical qubit is depicted. By applying the physical H gate to 9 data qubits D1 to D9, the quantum state of a logical qubit 200 changes from |ψ_{L} [symbol] to H|ψ_{L} [symbol] , and the X stabilizer 112 and the Z stabilizer 114 of FIG. 2 may be exchanged with a Z stabilizer 202 and an X stabilizer 203 in FIG. 3. Therefore, the X-Right flavor of FIGS. 1 and 2 may be transformed into a Z-Right flavor in FIG. 3. Consequently, the logical X operator 116 X_{L} and the logical Z operator 117 Z_{L} of FIG. 2 may be changed to the definition of a logical Z operator 204 Z_{L}^{H} and a logical X operator 205 X_{L}^{H} in FIG. 3.

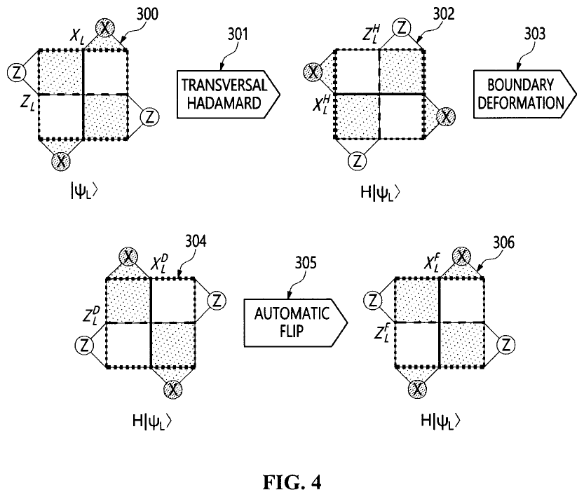

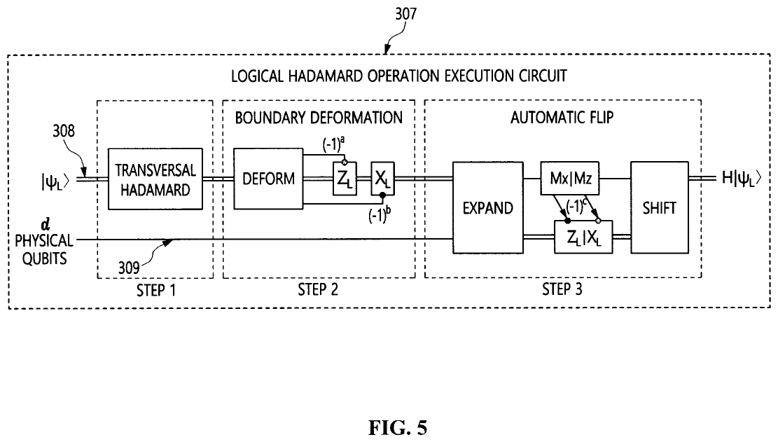

FIGS. 4 and 5 are diagrams illustrating a logical H gate operation process of a rotated surface code according to an embodiment of the present disclosure.

Referring to FIGS. 4 and 5, the logical H operation process in which a logical qubit flavor is maintained according to the embodiment of the present disclosure may include a transversal H step, a boundary deformation step, and an auto-flip step. Each step may be defined as an independent operation that can be selectively performed for each step if necessary.

In the transversal logical H step (first step, STEP 1), a transversal logical H gate 301 may be applied to a logical qubit 300 of an initial (prepared) encoding flavor having an arbitrary quantum state |ψ_{L} [symbol] . The quantum state of a Hadamard-transformed logical qubit 302 changes to H|ψ_{L} [symbol] , and the definitions of logical operators may be changed to Z_{L}^{H} and X_{L}^{H}.

The boundary deformation step (second step, STEP 2) may deform the boundary of the logical qubit while maintaining the logical quantum state H|ψ_{L} [symbol] using boundary [symbol] deformation technology 303 according to an embodiment of the present disclosure in 304. After the deformation, the logical operators may be defined as Z_{L}^{D} and X_{L}^{D}, and may return to Z_{L} and X_{L} of the prepared encoding flavor 300.

The auto-flip step (third step, STEP3) may transform the flavor of the local qubit to a flavor identical to the prepared encoding flavor while maintaining the logical quantum state H|ψ_{L} [symbol] using automatic flip technology 305 according to an embodiment of the present disclosure in 306. After the transformation, the logical operators may be defined as Z_{L}^{F} and X_{L}^{F}, and may be identical to the logical operators Z_{L} and X_{L} of the prepared encoding flavor 300.

The operation process proposed in the present disclosure may be equally applied to various flavors 104 to 107 according to the encoding scheme defined in FIG. 1.

The stepwise techniques in the logical H operation process may define logical operators, and may define a logical H operation execution circuit 307 based on the defined logical operators, as shown in FIG. 5. A double line 308 denotes an operation applied to the logical qubit, and a single line 309 denotes an operation applied to physical qubits of a size corresponding to distance d.

The boundary deformation defines a deform operator corresponding to a single logical qubit operation, and may correct a logical quantum state by applying the logical Z or X operator Z_{L}^{D} or X_{L}^{D} to the boundary-deformed logical qubit (LQ) 304 depending on two calculated values a and b.

The auto-flip may define an expand operator and a shift operator, and may flip the flavor of the logical qubit by selectively performing any one of vertical and horizontal flips depending on the logical qubit layout. A logical operator (Z_{L} and X_{L}) execution factor c is a value calculated from the expand operator.

The auto-flip may change the logical qubit flavor while maintaining the boundary. For example, an X-Left flavor may be changed to an X-Right flavor through the flip. The shift operator may be a swap operation between physical qubits, and may shift the logical qubit to the location of the logical qubit before being flipped.

The execution circuit may selectively perform respective steps depending on whether a logical operation to be subsequently performed after the logical H gate is applied to the logical qubit requires the same flavor as the prepared encoding flavor. For example, when a measurement operation is performed after the logical H operation, only the first step may be performed. Further, when the change in the flavor of the logical qubit is required as in the case of a lattice surgery-based multiple logical qubit operations, all steps may be performed.

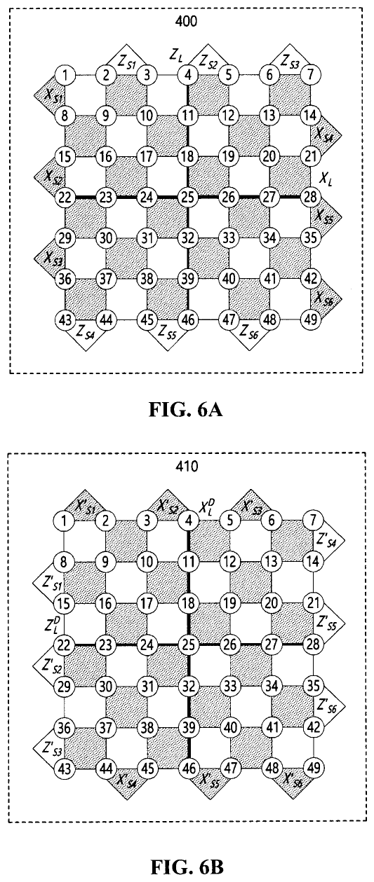

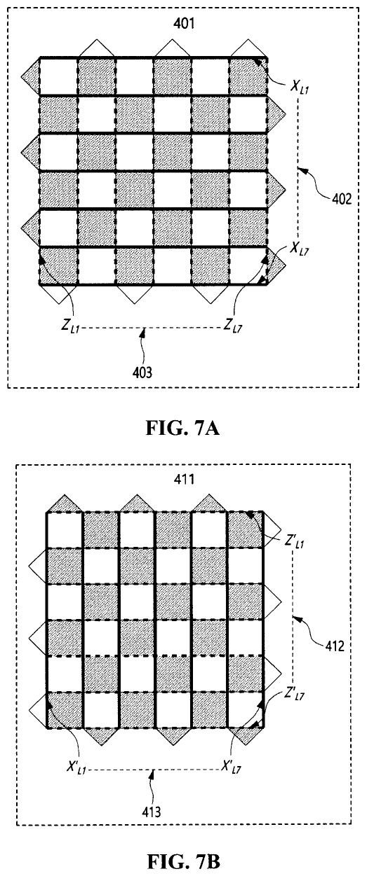

FIGS. 6 and 7 are diagrams illustrating boundary deformation technology for a rotated logical qubit according to an embodiment of the present disclosure.

Referring to FIGS. 6A and 6B and FIGS. 7A and 7B, boundary deformation may deform its boundary by controlling the activation of boundary stabilizers in the rotated logical qubit, and may exchange the definition of logical Pauli operators while maintaining a logical quantum state through post-correction.

The advantage of boundary deformation is in that the definition of logical Pauli operators can be changed to the original definition while maintaining the logical quantum state of a logical qubit in the current state thereof without causing a spatial overhead.

FIG. 6A shows an example of a form in which a d-7 Z-Right logical qubit 400 is deformed into an X-Left logical qubit 410 through the boundary deformation technology according to an embodiment of the present disclosure.

Boundary deformation may define a boundary stabilizer set of the Z-Right logical qubit 400 as S_{old}=<Z_{Si}, X_{Sj}> (index={i, j}, 0<index<d), and may define a boundary stabilizer set of the X-Left logical qubit 410 as S_{new}=<X′_{Si}, Z′_{Sj}> (index={i, j}, 0<index<d).

Boundary deformation may deactivate Z-boundary stabilizers Z_{S1} to Z_{S6} in an active state in the Z-Right logical qubit 400, and may activate X stabilizers X′_{S1} to X′_{S6} in an inactive state.

In the same manner, the boundary deformation may deactivate X boundary stabilizers X_{S1} to X_{S6} in an active state, and may activate Z stabilizers Z′_{S1} to Z′_{S6} in an inactive state. Here, activation refers to performing an ESM circuit in the corresponding stabilizer, and deactivation refers to not-performing the ESM circuit.

Conceptually, all paths between two pairs of boundaries in the rotated surface code may be defined as logical operators. It can be seen that FIG. 7A shows the definition of logical operators in the Z-Right logical qubit 400 in FIG. 6A in 401. Here, all paths between upper/lower Z boundaries may be defined as logical Z operators, and we call them as alternative logical Z operators 403 (Z_{L1} to Z_{L7}). These operators need to have the same parity, and the product of the parities also needs to be identical to the parity. Among the alternative operators, a representative logical Z operator Z_{L} may be defined, and the parity of the representative operator may be identical to the product of parities of the alternative operators. Similarly, all paths between left/right X boundaries may be alternative logical X operators 402 (X_{L1} to X_{L7}), which can be defined as logical X operators, and may have the same parity. The product of parities of the alternative operators may be identical to the parity, and the parity of a representative logical X operator X_{L} may be identical to the product of parities.

When the logical qubit is stabilized to the +1 eigenstate of all stabilizers, the parity of each alternative operator may be an even number. This means that the number of |1> states of data qubits defining each logical operator is an even number. Here, an even parity is defined as +1 and an odd parity is defined as −1. Because the parity of each alternative operator is an even number, the product of the parities and the parity of the representative operator are even numbers.

It can be seen that FIG. 7B illustrates the definition of logical operators of the boundary-deformed X-Left logical qubit 410 in FIG. 6B in 411. Here, all paths between the upper/lower X boundaries may be alternative operators 413 (X′_{L1} to X′_{L7}), which can be defined as logical X operators. The alternative operators may have the same parity X_{Li}^{parity}, and the product of parities mₓ may be identical to the parity. The parity of a representative logical X operator X_{L}^{D} may be identical to mₓ. Similarly, all paths between left/right Z boundaries may be alternative operators 412 (Z′_{L1} to Z′_{L7}), which can be defined as logical Z operators. The alternative operators have the same parity Z_{Li}^{parity}, and the product of the parities m_{z} may be identical to the parity. Also, the parity of a representative logical Z operator Z_{L}^{D} may be identical to m_{z}. The parity product of individual operators and the quantum state |ψ_{L}^{D} [symbol] of the boundary-deformed logical qubit are represented by formulas, as shown in Equations (1) and (2), respectively.

$${m}_{p} = {\prod }_{i = 1}^{d} {P}_{Li}^{parity} \qquad ( 1 )$$

$$\vert {ψ}_{L}^{D} 〉 = {( {Z}_{L}^{D} )}^{a} {( {X}_{L}^{D} )}^{b} \vert {ψ}_{L}^{P} 〉 \qquad ( 2 )$$

Here, an operator set P may be P=<X, Z>, P_{Li}^{parity} may be the parity of each alternative operator, and execution factors a and b of the logical Z and X operators Z_{L}^{D} and X_{L}^{D} may be calculated from mₓ=(−1)^{a} and m_{z}=(−1)^{b} which are the parity products of the alternative logical X and Z operators. That is, when the parity product is −1, the execution factor may have a value of 1, whereas when the parity product is +1, the execution factor may have a value of 0. Finally, |ψ_{L}^{P} [symbol] may indicate the quantum state of the logical qubit before boundary deformation is performed.

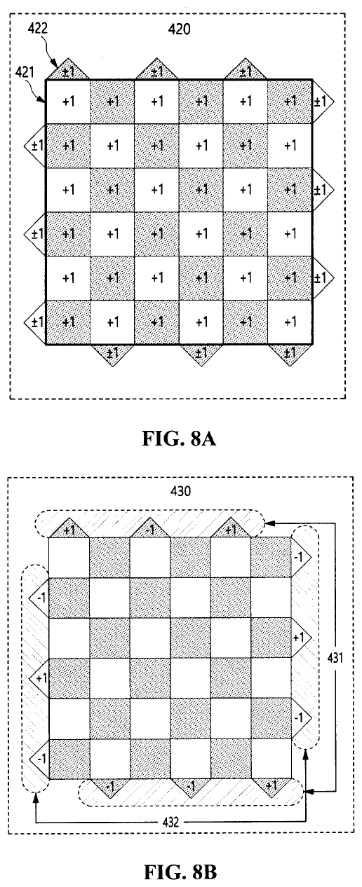

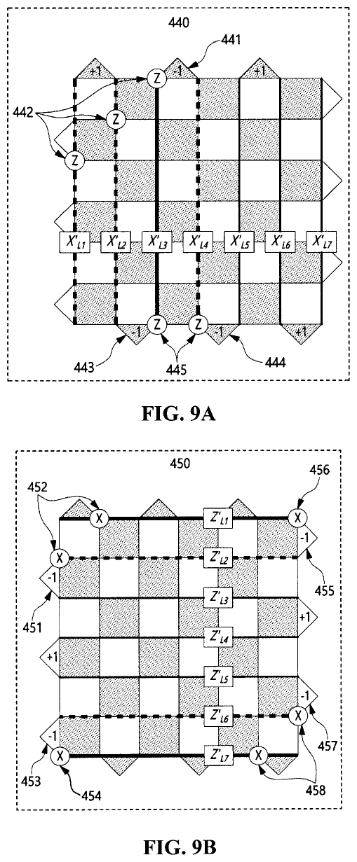

FIGS. 8A and 8B and FIGS. 9A and 9B are diagrams illustrating a process of preserving a logical quantum state in boundary deformation technology according to an embodiment of the present disclosure.

FIG. 8A shows possible outcomes obtained in stabilizer measurement for boundary deformation (420). The measurement outcomes of non-deformed weight-4 stabilizers 421 appear as +1, but the measurement outcomes of weight-2 stabilizers 422 at a newly activated boundary randomly appear as ±1. The reason for obtaining the random outcomes is that boundary stabilizers, before and after deformation, anti-commute with each other in a single data qubit. In the algebra of Pauli operators, the application of the Pauli operators to different single qubits may commute with each other (i.e., for data qubits a and b, [Xₐ, Z_{b}]=0). However, the application of the Pauli operators to the same single qubit may be defined to anti-commute with each other (i.e., for data qubit a, [Xₐ, Zₐ]≠0). In FIGS. 7A and 7B and FIGS. 8A and 8B, when two operators commute with each other for stabilizer Z_{S1} and stabilizer X′_{S1} deformed from stabilizer Z_{S1}, [A, B]=BA−AB=0 may be satisfied. However, when this is checked by stabilizer operators, [Z_{S1}, X′_{S1}]=(x₂x₁)(z₃z₂)−(z₃z₂)(x₂x₁)=(x₂x₁)(z₃z₂)−(−(x₂x₁)(z₃z₂))≠0 is obtained, and Pauli X and Z operators are applied to a single data qubit 2, and thus it can be seen that the operators anti-commute with each other. In the same manner, because elements of S_{old} and elements of S_{new} deformed therefrom anti-commute with each other (i.e., [Z_{Si}, X′_{Si}]≠0, [X_{Si}, Z′_{Si}]≠0, 0<i<d), the stabilizer measurement outcomes of S_{new} may randomly appear as ±1.

If in FIG. 8A, all of measurement outcomes of the boundary stabilizers 422 are +1, the quantum state of the boundary-deformed X-Left logical qubit may be identical to the quantum state of the Z-Right logical qubit before being deformed. Therefore, by means of the proposed boundary deformation technology, it can be seen that a logical H operation in which the definitions of logical operators (X_{L}, Z_{L}) are maintained has been performed.

Unlike this, as shown in FIG. 8B, when a measurement outcome of −1 is output from the boundary stabilizers, a method for preserving logical quantum states may be applied. The method for preserving logical quantum states may preserve the logical quantum states by decoding stabilizers measured as −1, stabilizing the stabilizers back to +1, tracking the parity change of the alternative operators during this procedure, and applying logical Pauli operators depending on the result of a parity product.

As described above, a syndrome generated when the two stabilizer operators anti-commute with each other in a single data qubit may be stabilized to +1 by applying a correction operation to designated data qubits through decoding similarly to other errors. Regardless of whether correction paths provided depending on the decoders are different, the method for preserving logical quantum states proposed in the present patent may be equally applied.

FIG. 9A illustrates a correction path applied during a process of stabilizing Z syndromes at upper/lower boundaries in FIG. 8B and the parity changes of alternative logical X operators X′_{L1} to X′_{L7} depending on the correction path (440). Here, among the alternative operators, dotted lines on X′_{L1}, X′_{L2}, and X′_{L4} denote operators in which parity is flipped an odd number of times, a straight line on X′_{L3} denotes an operator in which parity is flipped an even number of times, and three solid lines on X′_{S5}, X′_{S6}, and X′_{S7} denote operators to which a correction operation is not applied. FIGS. 9A and 9B show that stabilizers are decoded so that a Pauli-Z operator is applied to data qubits 3-9-15 (442) and 45-46 (445) in order to stabilize Z syndromes 441, 443, and 444 occurring on X′_{S2}, X′_{S4}, and X′_{S5}. As a result, all stabilizers including X′_{S2}, X′_{S4}, and X′_{S5} are stabilized to a +1 state. However, from the standpoint of alternative operators, it can be seen that the Pauli-Z operator is applied once to X′_{L1}, X′_{L2}, and X′_{L4}, and is applied twice to X′_{L3}. According to the algebra of Pauli operators, when X²=Z²=I, that is, when the same operator is successively applied an even number of times, the corresponding parity may return to the original state thereof. Therefore, the parity of X′_{L3} may return to the original state thereof, whereas the parities of X′_{L1}, X′_{L2}, and X′_{L4} may be flipped from +1 to −1. When an odd number of alternative operators are flipped to −1, the parity product mₓ is also flipped to −1, which may indicate that a logical phase-flip error has occurred. Therefore, the logical phase state before being deformed may be preserved by applying a logical Z operator Z° to the boundary-deformed X-Left logical qubit.

FIG. 9B illustrates a correction path applied during a process of stabilizing X syndromes at left/right boundaries in FIG. 8B and the parity change of alternative logical X operators Z′_{L1} to Z′_{L7} depending on the correction path (450). In FIG. 9B, among alternative operators, dotted lines on Z′_{S2} and Z′_{S6} denote an operator in which parity is flipped an odd number of times, straight lines on Z′_{L1} and Z′_{L7} denote an operator in which parity is flipped an even number of times, and three solid lines on Z′_{S3}, Z′_{S4}, and Z′_{S5} denote operators to which a correction operation is not applied. This example shows that stabilizers are decoded so that a Pauli-X operator is applied to data qubits 2-8(452), 7(456), 43(454), and 42-48(458) in order to stabilize X syndromes 451, 453, 455, and 457 occurring on Z′_{S1}, Z′_{S3}, Z′_{S4}, and Z′_{S6}. As a result, all stabilizers including Z′_{S1}, Z′_{S3}, Z′_{S4}, and Z′_{S6} are stabilized to +1 state. However, from the standpoint of alternative operators, it can be seen that the Pauli-X operator is applied once to Z′_{L2} and Z′_{L6} and is applied twice to Z′_{L1} and Z′_{L7}. Therefore, the parities of Z′_{L1} and Z′_{L7} may return to the original states thereof, whereas the parities of Z′_{L2} and Z′_{L6} may be flipped to −1. Because an even number of alternative operators are flipped to −1, the parity product m_{z} may be maintained at +1, which indicates that no logical bit-flip error is present.

By means of the logical quantum state preservation method illustrated in FIGS. 9A and 9B, the boundary-deformed logical qubits may preserve the quantum states |ψ_{L}^{D} [symbol] =H |ψ_{L} [symbol] before being deformed, without causing logical errors.

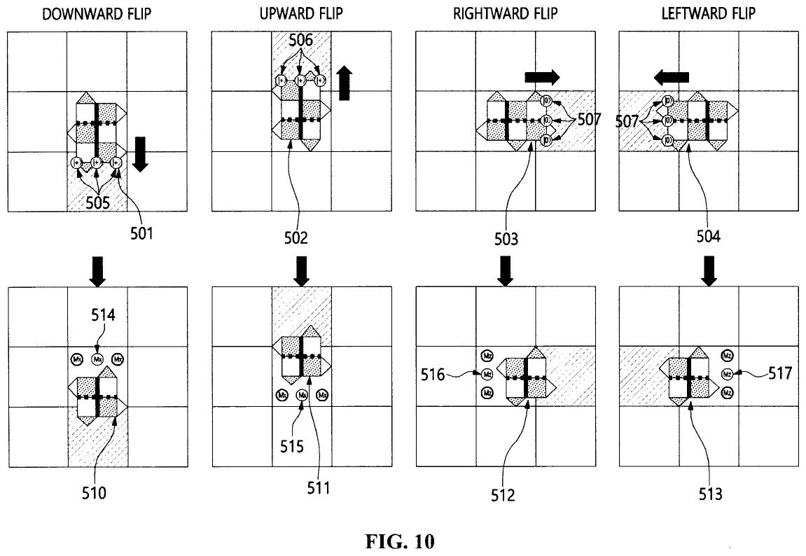

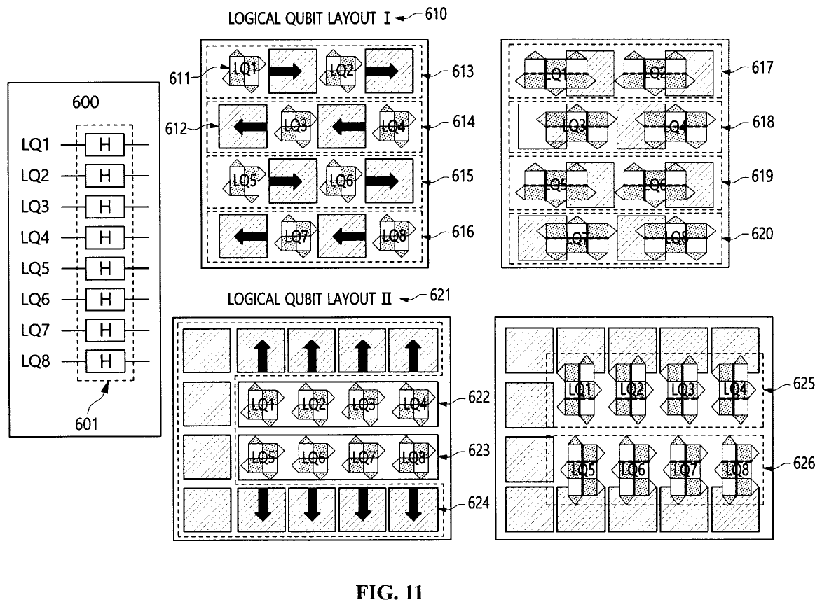

FIG. 10 illustrates location-based automatic flip technology in a rotated logical qubit according to an embodiment of the present disclosure.

Referring to FIG. 10, the flip of a logical qubit may be technology for deforming the flavor of the logical qubit by vertically or horizontally flipping the rotated surface code while maintaining a logical quantum state and logical operator definitions. The present disclosure proposes logical qubit auto-flip technology which utilizes the origin location of the logical qubit and the location information of available physical qubits. Here, the location information of logical and physical qubits may include both of the case where it is passively provided and the case where it is intelligently managed.

When available physical qubits are present above or below the origin of the logical qubit, a downward flip 501 or an upward flip 502 which is vertically defined is performed, whereas when available physical qubits are present to the left or right of the origin of the logical qubit, a rightward flip 503 or a leftward flip 504 which is horizontally defined may be performed.

The auto-flip technology may construct an expanded logical qubit by adding physical qubits of size d to a target logical qubit desired to be flipped, measuring the physical qubits of size d, and then extracting a flipped logical qubit. Depending on which boundary is used as a reference to expand the logical qubit, the initialization and measurement basis of the physical qubits may be defined. When the target logical qubit has an X-Left flavor, the vertical flips 501 and 502 may be expanded with respect to the X boundary, and thus additional d physical qubits may be initialized to the state of |+ [symbol] (505 and 506), and the d physical qubits may be measured in the X-basis (Mx) when the logical qubit is extracted (510 and 511). The measurement outcomes of data qubits 514 and 515 which were the logical X operators determine the value of (−1)^{c} in the execution circuit of FIG. 5, and a logical Z operator may be applied to the extracted logical qubit depending on the determined value. Unlike this, the horizontal flips 503 and 504 may be expanded with respect to the Z bounda and thus the additional d physical qubits may be initialized to the state of |0 [symbol] (507), and the d physical qubits may be measured in the Z-basis (Mz) when the logical qubit is extracted (512 and 513). The logical X operator may be applied to the logical qubits extracted depending on the outcomes of measurement of data qubits 516 and 517 which were logical Z operators among the measurement qubits.

Finally, the extracted logical qubits 510 to 513 may be shifted to the original location by utilizing a swap operation between the physical qubits.

The method for performing a logical H gate operation while maintaining the flavor of a surface code logical qubit using physical qubits according to an embodiment of the present disclosure may also support the parallel processing of multiple logical H gates.

For this operation, a circuit for performing multiple rotated logical qubits in parallel will be described by way of example. Here, a parallel processing method in technology which proposes, as examples, layout I in which logical data qubits, which are logical qubit layouts (LQ layouts), and ancillary spaces are alternately arranged, and layout II in which logical data qubits are arranged in rows and ancillary spaces are arranged in rows and columns adjacent to the logical data qubits will be described below. In addition, in all layouts in which logical data qubits and ancillary spaces are arranged, single processing or parallel processing may be supported by utilizing the technology proposed in the present disclosure.

FIG. 11 is a diagram illustrating an example of parallel processing of multiple logical H gate operations in logical qubit layouts according to an embodiment of the present disclosure.

Referring to FIG. 11, it can be seen that a circuit in which logical H gates 601 are simultaneously applied to eight logical qubits LQ1 to LQ8 (600) is assumed, and a method for performing the circuit in parallel in two layouts is illustrated.

A logical qubit layout I 610 is a structure in which logical data qubits 611 and ancillary spaces 612 are alternately arranged, and shows an optimal structure in performing a LS-based logical CNOT gate operation.

In the logical qubit layout I 610, two logical data qubits are alternately arranged in each row (613 to 616), and ancillary spaces are defined therebetween. In this layout, a first row 613 and a third row 615 have available physical qubits in ancillary spaces located to the right of the logical data qubits, and a second row 614 and a fourth row 616 have available physical qubits in ancillary spaces located to the left of the logical data qubits. Therefore, a first row 617 and a third row 619 may flip the logical qubits in parallel in a rightward flip manner at the same time that a second row 618 and a fourth row 620 may flip the logical qubits in parallel in a leftward flip manner. When all horizontally flipped logical qubits are shifted to the origins 613 to 616, the prepared encoding flavor in which quantum states before the logical qubits are flipped are preserved may be obtained.

It can be seen that the logical qubit layout II 621 is a structure in which logical data qubits are arranged in rows and ancillary spaces are arranged in rows and columns adjacent to the logical data qubits and is a structure profitable to apply multiple logical CNOT gates.

The logical qubit layout II 621 defines logical data qubits in units of four in two rows 622 and 623, and ancillary spaces 624 having the same size as the logical data qubits are defined in the rows and columns adjacent to the rows of the logical data qubits. In this layout, logical data qubits LQ1 to LQ4 in a first row have available physical qubits in ancillary spaces located above the logical qubits, and logical data qubits LQ5 to LQ8 in a second row have available physical qubits in ancillary spaces located below the logical qubits. Therefore, the first row may flip the logical qubits in parallel in an upward flip manner (625) at the same time that the second row may flip the logical qubits in a downward flip manner (626). When all vertically-flipped logical qubits are shifted to the origins 622 and 623, the prepared encoding flavor in which quantum states before being flipped are preserved may be obtained.

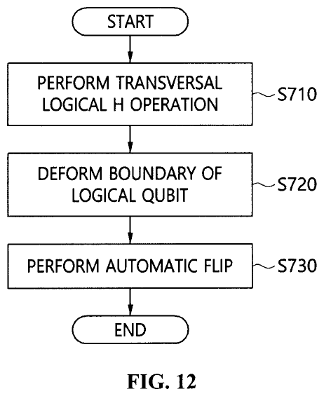

FIG. 12 is an operation flowchart illustrating a method for performing a fault-tolerant logical Hadamard (H) gate operation according to an embodiment of the present disclosure.

Referring to FIG. 12, the method for performing the logical Hadamard gate operation according to the embodiment of the present disclosure may perform a transversal logical H operation at step S710.

That is, at step S710, a transversal logical H gate (301) operation of defining the logical quantum state and logical operators of a Hadamard-transformed logical qubit may be performed on a logical qubit 300 of an initial (prepared) encoding flavor having an arbitrary quantum state |ψ_{L} [symbol] in 302.

Here, at step S710, the quantum state of the Hadamard-transformed logical qubit may be changed to H|ψ_{L} [symbol] , and the definitions of the logical operators may be changed to Z_{L}^{H} and X_{L}^{H}.

In this case, at step S710, the logical operators may be defined, and a logical H operation execution circuit 307 may be defined based on the logical operators.

Further, the method for performing the fault-tolerant logical Hadamard gate operation according to the embodiment of the present disclosure may deform the boundary of the logical qubit at step S720.

That is, at step S720, the boundary of the logical qubit may be deformed while the logical quantum state H|ψ_{L} [symbol] is maintained using boundary deformation technology 303 in 304.

Here, at step S720, after deformation, the definitions of the logical operators may be Z_{L}^{D} and X_{L}^{D}, and may then return to Z_{L} and X_{L} of the prepared encoding flavor 300.

Here, at step S720, a deform operator corresponding to a single logical qubit operation may be defined, and the logical quantum state may be corrected by applying a logical Z or X operator Z_{L}^{D} or X_{L}^{D} to the boundary-deformed logical qubit (LQ) 304 depending on two calculated values a and b.

Here, at step S720, the boundary may be deformed by controlling the activation of a boundary stabilizer in a rotated logical qubit, and the definitions of the logical operators may be changed while the logical quantum state is maintained through post-correction.

Furthermore, the method for performing the logical Hadamard gate operation according to the embodiment of the present disclosure may perform an automatic flip at step S730.

That is, at step S730, the flavor of the logical qubit may be transformed by vertically or horizontally flipping the rotated surface code while the logical quantum state and the definitions of logical operators are maintained.

Here, at step S730, the flavor of the local qubit may be transformed into the flavor identical to the prepared encoding flavor while the logical quantum state H|ψ_{L} [symbol] is maintained using automatic flip technology 305 in 306. After the transformation, the definitions of the logical operators are Z_{L}^{F} and X_{L}^{F}, and may be identical to the logical operators Z_{L} and X_{L} of the prepared encoding flavor 300.

Here, at step S730, an expand operator and a shift operator may be defined, and the flavor of the logical qubit may be flipped by selectively performing any one of vertical and horizontal flips depending on the logical qubit layout. A logical operator (Z_{L} and X_{L}) execution factor c is a value calculated from the expand operator.

Here, step S730 may be performed such that, when available physical qubits are present above or below the origin of the logical qubit, a downward flip 501 or an upward flip 502, which is vertically defined, is performed, whereas when available physical qubits are present to the left or right of the origin of the logical qubit, a rightward flip 503 or a leftward flip 504, which is horizontally defined, is performed.

Here, at step S730, the flavor of the logical qubit may be changed while the boundary is maintained.

For example, at step S730, an X-Left flavor may be changed to an X-Right flavor. Here, at step S730, the shift operator may be shifted to the location of the logical qubit before being flipped through a swap operation between the physical qubits.

Here, at step S730, after an expanded logical qubit may be constructed by adding physical qubits of size d to a target logical qubit desired to be flipped, the physical qubits of size d may be measured, and then the flipped logical qubit may be extracted.

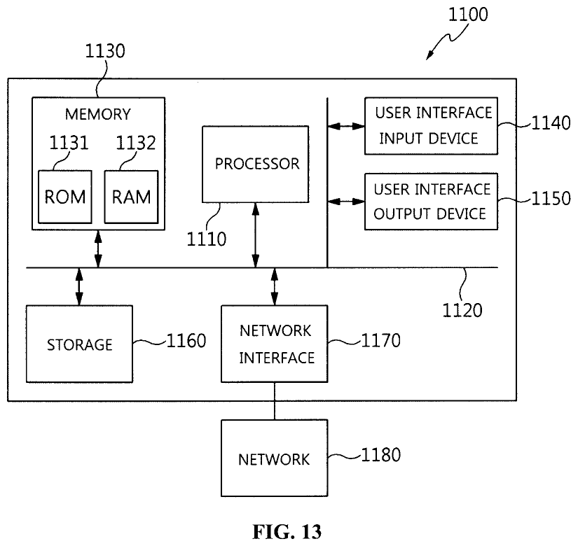

FIG. 13 is a diagram illustrating a computer system according to an embodiment of the present disclosure.

Referring to FIG. 13, an apparatus for performing a fault-tolerant logical Hadamard gate operation according to embodiments of the present disclosure may be implemented in a computer system 1100 such as a computer-readable storage medium. As illustrated in FIG. 13, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

An apparatus for performing a fault-tolerant logical Hadamard gate operation according to an embodiment of the present disclosure may include one or more processors 1110, and memory 1130 configured to store at least one program that is executed by the one or more processors 1110, wherein the at least one program is configured to perform a transversal logical Hadamard (H) operation of defining a logical quantum state and a logical operator of a Hadamard-transformed logical qubit on a logical qubit of a prepared encoding flavor having an arbitrary quantum state, deform a boundary of the logical qubit while maintaining the logical quantum state using a boundary deformation technology, and perform an automatic flip of transforming a flavor of the logical qubit by flipping a rotated surface code while maintaining the logical quantum state and a definition of the logical operator.

Here, the at least one program may be configured to define a logical H operation execution circuit based on the definition of the logical operator.

Here, the at least one program may be configured to define a deform operator corresponding to a single logical qubit operation and correct the logical quantum state by applying the logical operator to the boundary-deformed logical qubit depending on two calculated values.

Here, the at least one program may be configured to deform the boundary by controlling activation of a boundary stabilizer in a rotated logical qubit, and to change the definition of the logical operator while maintaining the logical quantum state through post-correction.

Here, the at least one program may be configured to define an expand operator and a shift operator and to flip the flavor of the logical qubit by selectively performing any one of a vertical flip and a horizontal flip depending on a layout of the logical qubit.

Here, the at least one program may be configured to construct an expanded logical qubit by adding a physical qubit of a preset size to the logical qubit, and thereafter extract a flipped logical qubit by measuring the physical qubit of the preset size.

The present disclosure may solve the problem in which logical X and Z operators are mutually exchanged with each other as a quantum state is Hadamard-transformed when a transversal logical H gate is applied to quantum error correction code.

Further, the present disclosure may provide a method for preventing a rotated logical qubit from influencing a logical quantum state, minimizing an influence on the quantum state and operation of adjacent other logical qubits, and decreasing the number of necessary physical qubits and a physical qubit computational load.

Furthermore, the present disclosure may reduce the number of processing steps of a quantum circuit by performing logical H gate operations in parallel on multiple rotated logical qubits.

As described above, in the apparatus and method for performing a fault-tolerant logical Hadamard gate operation according to the present disclosure, the configurations and schemes in the above-described embodiments are not limitedly applied, and some or all of the above embodiments can be selectively combined and configured so that various modifications are possible.

What is claimed is:

1. An apparatus for performing a fault-tolerant logical Hadamard gate operation, comprising:
one or more processors; and
a memory configured to store at least one program that is executed by the one or more processors,
wherein the at least one program is configured to:
perform a transversal logical Hadamard (H) operation of defining a logical quantum state and a logical operator of a Hadamard-transformed logical qubit on a logical qubit of a prepared encoding flavor having an arbitrary quantum state,
deform a boundary of the logical qubit while maintaining the logical quantum state using a boundary deformation technology, and
perform an automatic flip of transforming a flavor of the logical qubit by flipping a rotated surface code while maintaining the logical quantum state and a definition of the logical operator.

2. The apparatus of claim 1, wherein the at least one program is configured to define a logical H operation execution circuit based on the definition of the logical operator.

3. The apparatus of claim 2, wherein the at least one program is configured to define a deform operator corresponding to a single logical qubit operation and correct the logical quantum state by applying the logical operator to the boundary-deformed logical qubit depending on two calculated values.

4. The apparatus of claim 3, wherein the at least one program is configured to deform the boundary by controlling activation of a boundary stabilizer in a rotated logical qubit, and to change the definition of the logical operator while maintaining the logical quantum state through post-correction.

5. The apparatus of claim 4, wherein the at least one program is configured to define an expand operator and a shift operator and to flip the flavor of the logical qubit by selectively performing any one of a vertical flip and a horizontal flip depending on a layout of the logical qubit.

6. The apparatus of claim 5, wherein the at least one program is configured to construct an expanded logical qubit by adding a physical qubit of a preset size to the logical qubit, and thereafter extract a flipped logical qubit by measuring the physical qubit of the preset size.

7. A method for performing a fault-tolerant logical Hadamard gate operation, the method being performed by an apparatus for performing a fault-tolerant logical Hadamard gate operation, the method comprising:
performing a transversal logical Hadamard (H) operation of defining a logical quantum state and a logical operator of a Hadamard-transformed logical qubit on a logical qubit of a prepared encoding flavor having an arbitrary quantum state;
deforming a boundary of the logical qubit while maintaining the logical quantum state using a boundary deformation technology; and
performing an automatic flip of transforming a flavor of the logical qubit by flipping a rotated surface code while maintaining the logical quantum state and a definition of the logical operator.

8. The method of claim 7, wherein performing the transversal logical H operation comprises:
defining a logical H operation execution circuit based on the definition of the logical operator.

9. The method of claim 8, wherein deforming the boundary comprises:
defining a deform operator corresponding to a single logical qubit operation, and correcting the logical quantum state by applying the logical operator to the boundary-deformed logical qubit depending on two calculated values.

10. The method of claim 9, wherein deforming the boundary further comprises:
deforming the boundary by controlling activation of a boundary stabilizer in a rotated logical qubit, and changing the definition of the logical operator while maintaining the logical quantum state through post-correction.

11. The method of claim 10, wherein performing the automatic flip comprises:
defining an expand operator and a shift operator, and flipping the flavor of the logical qubit by selectively performing any one of a vertical flip and a horizontal flip depending on a layout of the logical qubit.

12. The method of claim 11, wherein performing the automatic flip further comprises:
constructing an expanded logical qubit by adding a physical qubit of a preset size to the logical qubit, and thereafter extracting a flipped logical qubit by measuring the physical qubit of the preset size.
